(19) United States
(12) Patent Application Publication
(10) Pub. No.: US 2004/0140343 A1
(43) Pub. Date: Jul. 22, 2004

(54) Vent hole sealing of hermetic packages

(76) Inventors: Wenlin Jin, Ottawa (CA); David Hess, Aylmer (CA)

Correspondence Address: Juliusz Szereszewski, Intellectual Property Dept., JDS Uniphase Corporation, 3000 Merivale Road, Ottawa, ON, K2G 6N7, CA

(21) Appl. No.: 10/348,005

(22) Filed: Jan. 22, 2003

(51) Int. Cl. B23K 35/12

(52) U.S. Cl. 228/246

(57) ABSTRACT

A hermetic package useful in optical communications, for example to house a MEMS switch, a semiconductor laser or a dynamic gain equalizer, has at least one vent opening that is sealed, following the assembly of the package, by inserting a solder plug into the vent opening and cold-pressing the solder by into the opening, preferably by screwing-in a bolt into a threaded part of the vent opening, until the solder is deformed to seal the vent opening. Preferably, the indium-tin or bismuth-tin solder is pushed down until it partially exits from a narrower portion of the vent opening into the package cavity. Following the plug deformation, the bolt may be withdrawn or left in place. The approach is simple and eliminates the conventional step of melting the solder.

### RELATED APPLICATIONS

Not applicable.

### TECHNICAL FIELD

This invention relates to hermetic packages, and particularly to small hermetic packages having vent holes.

### BACKGROUND OF THE INVENTION

Hermetic packages are commonly known in many areas of technology, i.e. in telecommunications. Lasers, wave blockers, dynamic gain equalizers, MEMS (micro-electro-mechanical systems) and other devices are frequently placed in sealed (hermetic) packages for protection against accidental damage or environmental factors e.g. humidity or air pollution.

Large diffraction based devices are sensitive to the refractive index of the gas within which they operate. These devices are therefore sealed in hermetic packaging to maintain the quantity and composition of the gas within their packaging. For example, some current packaging technologies require that a minimum of 10% helium be trapped within the hermetic package to determine hermeticity (by helium leak detection).

A typical hermetic package is composed of two or more components, one of them serving as a lid. After the desired element or elements are properly placed and secured in one component of the package, the lid may be put in place and sealed by various means known in the art. The lid (or another component of the package) may have one or more venting holes for maintaining atmospheric pressure inside the package and/or for relieving any gases present inside the package as a result of the manufacturing process steps (e.g. using a solvent). The venting holes in hermetic packages for the purpose of telecommunications equipment are typically of a small diameter, in the order of a few millimeter or less.

The venting hole(s) or opening(s) should eventually be sealed for a full hermeticity of the package. This can be accomplished for example, according to the prior art, by placing an amount of a metallic solder, e.g. a “plug” of solder, in the hole and then heat the hole area to a temperature sufficient to cause the solder to melt and seal the hole.

A rather complicated multi-step method of sealing a semiconductor device using molten solder and screws is disclosed in Japanese Patent Application (abstract) No. 07001729 (publ. No. 8191117) filed Oct. 1, 1995.

It is an object of the invention to provide a simple and efficient method of sealing a hermetic package having one or more vent holes. It is also an object of the invention to provide a hermetic package sealed by such method.

### SUMMARY OF THE INVENTION

In accordance with one aspect of the invention, there is provided a method of sealing a hermetic package having at least one wall and at least one vent opening extending through the wall to connect the inside of the package with the outside thereof. The method comprises the steps of:

introducing a plug of a malleable non-resilient material into the vent opening, and

without melting, applying a pressure, or in other words, forcing the plug into the vent opening to cause the plug to deform and assume a shape conforming to a shape of the opening around the plug thereby sealing the opening.

After the forcing step, any means used to force the plug into the vent opening may be withdrawn. Alternatively, the means may be left in place.

The material of the plug should be such as to undergo negligible or no shape reversal due to material's hysteresis when the deforming force is released. In other words, the deformed plug should maintain the seal of the venting opening after the force is released e.g. by withdrawing the forcing means. If a material with a degree of elasticity, or resilience, typical of e.g. certain polymers, were used for the purposes of the present invention, then upon the withdrawal of the deforming force, the material could exhibit some undesirable shrinkage leading to a loss of seal.

Preferably and advantageously, the forcing step is effected without providing heat to the plug material and without melting the plug material by any means.

In an embodiment of the invention, the vent opening may have a larger first diameter at the outside of the wall that the opening extends through, and a smaller second diameter at the inside of the wall. In an embodiment of the invention, the opening has a conical portion or a funnel portion between the first and second diameter. In an embodiment of the invention, the vent opening has a tubular channel extending between the funnel portion and the inside of the wall, the diameter of the channel corresponding to the second diameter of the opening.

In an embodiment of the invention, at least part of the opening is threaded and the forcing means is a threaded element adapted for being threaded into the opening to cause a plastic deformation of the malleable plug material thereby sealing the vent opening.

### BRIEF DESCRIPTION OF THE DRAWINGS

Further features and advantages of the present invention will become apparent from the following detailed description taken in conjunction with the appended drawings in which:

FIG. 1 is an exploded perspective view of an exemplary package with a venting opening in the lid,

FIG. 2 is a top plan view of a base of another embodiment of a package of the invention before sealing,

FIG. 3 is a cross-sectional view along the line A-A of FIG. 2,

FIG. 4 is a cross-sectional view along the line B-B of FIG. 2,

FIG. 5 is an enlarged cross-sectional view of the element “C” of FIG. 4,

FIGS. 6, 7 and 8 are partial cross-sectional views of an embodiment of the package of the invention showing the vent opening in various phases of sealing.

It will be noted that throughout the appended drawings, like features are identified by like reference numerals.

### DETAILED DESCRIPTION OF THE INVENTION

Referring now to FIG. 1, an exemplary package used in telecommunication is shown. The package has a main body 10 and a lid 12. The body 10, as also seen in FIG. 3, defines a bottom wall 14 and a side wall 16. The lid has a top wall 18 with a venting hole 20 therethrough. When the lid 12 is applied against the body 10 as indicated schematically with the dashed lines, the hole provides a vent connecting the inside of the package with the outside thereof.

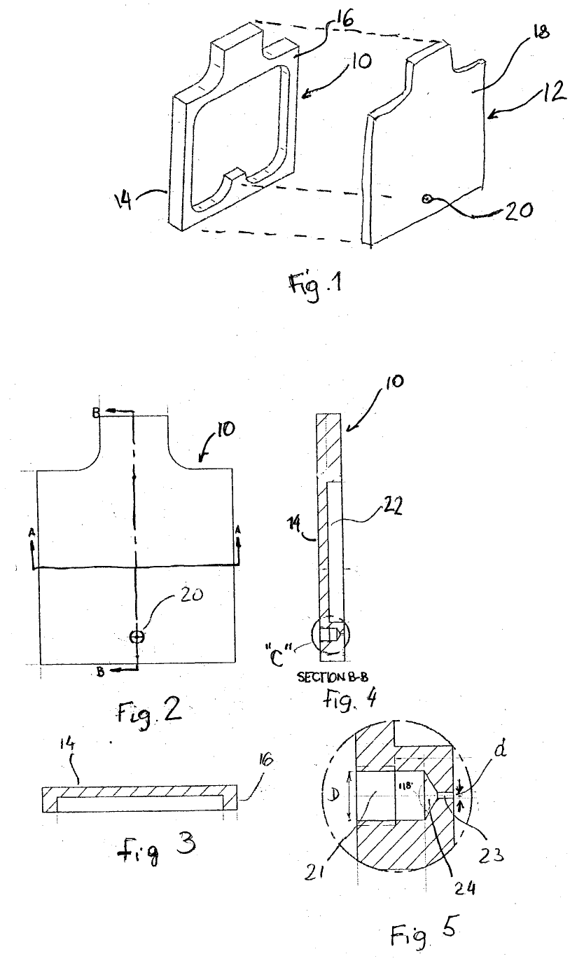

The embodiment of FIG. 2 shows a base 10 of a hermetic package similar to that of FIG. 1 except that a venting hole 20 is provided in the base rather than in a lid, not shown in FIG. 2. FIG. 3 shows a cross-section of FIG. 2 along the lines A-A, and FIG. 4 is a cross-section of FIG. 2 along the lines B-B. In FIG. 4, the area of an exemplary venting opening 20 is marked as “C” and is shown in more detail in FIG. 5.

In the embodiment illustrated in FIG. 5, the venting opening defines a first cylindrical portion 21 having a large diameter D at the outside surface 14 of the base 10, a second tubular portion 23 having a small diameter d at the inside surface 22 of the base 10 (FIG. 4) and a conical, or funnel-shaped portion 24 extending between the portions 21 and 23. This configuration is advantageous for the purposes of facilitating the conformity of shape of a sealing plug when pressed into the venting opening. However, it is easily conceivable to apply venting openings of various other shapes, e.g. frusto-conical, tubular (of any cross-sectional shape) with monotonically variable diameter and many others.

The sealing operation will be illustrated in conjunction with FIGS. 6, 7 and 8. In these figures, another embodiment of the package is shown. For simplicity, the package is illustrated only in part to feature a body 10 and a lid 12 of the package joined e.g. by soldering. In FIG. 6, a venting opening 20 is shown before sealing. The larger portion 21 of the opening is threaded. A slot 25 is cut into the wall of the body 10 in a manner to create a communication between the hole 20, specifically its second tubular portion, and the inside of the package, the communication necessary for the venting function. The purpose of the slot is also to create a retention wall area 26 opposite the entry of the tubular portion 23 into the slot 25. The function of the retention wall will be explained below.

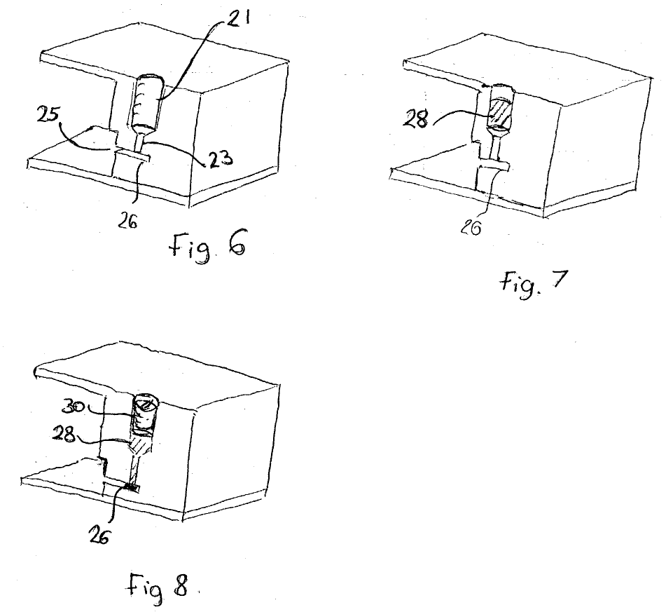

As shown in FIG. 7, a cylindrical pellet 28 of a bismuth-tin solder (or an indium-tin solder), either solder available on the market, is placed in the larger cylindrical portion 21 of the venting opening. The diameter of the pellet 28 should be slightly lower than the diameter of the portion 21 to facilitate the insertion of the pellet. The length of the pellet (in the vertical direction in FIG. 7) should be such as to expose a certain length of the thread in the portion 21.

Next, a threaded bolt 30 or another threaded element, with the thread matching the portion 21, in introduced into the opening and forced, by turning, to push the pellet towards the slot 25 and the retention wall area 26. The diameters of the opening 20 and the hardness of the solder should be selected such that the pellet deforms under the pressure exerted through the bolt 30, filling the entire smaller portion 23 and overflowing into the slot so as to contact the retaining wall area 26 as shown in FIG. 8. The retaining wall provides a point of resistance and thus facilitates the filling of the conical area and the smaller portion of the vent opening 20.

The temperature of the forcing operation may be the room temperature or a slightly elevated temperature e.g. due to friction or external heating, insufficient to melt the solder. The advantage of the invention is however realized by avoiding the melting of the solder and preferably any heating of the vent opening area. In other words, heating of the vent opening area and of the solder is not necessary according to the invention and is redundant.

Following the forcing step, once the proper filling and sealing of the vent opening has taken place, as illustrated in FIG. 8, the bolt 30 may be withdrawn. Alternatively, the bolt may be left in place. Advantageously, the bolt may be replaced by a countersunk screw or a set screw to eliminate unnecessary surface protrusion.

The embodiment(s) of the invention described above is(are) intended to be exemplary only. The scope of the invention is therefore intended to be limited solely by the scope of the appended claims.

1. A method of sealing a hermetic package having at least one wall and at least one vent opening extending through the wall, the method comprising the steps of:
introducing a plug of a malleable non-resilient material into the vent opening, and
applying a pressure on the plug without melting it to force the plug into the vent opening toward the inside of the package to cause the plug to deform and assume a shape conforming to a shape of the opening around the plug thereby sealing the opening.

2. The method of claim 1 wherein the pressure is released after the sealing has been effected.

3. The method of claim 1 wherein a pushing element is used to apply the pressure on the plug.

4. The method of claim 3 wherein the pushing element is a screw or bolt and at least a part of the vent opening is threaded.

5. The method of claim 1 wherein the plug is of a malleable material capable of plastic deformation with negligible or no shape hysteresis.

6. The method of claim 1 wherein the plug material is one of a bismuth-tin solder and an indium-tin solder.

7. The method of claim 1 wherein the vent opening comprises a conical portion.

8. The method of claim 1 wherein the package comprises a cavity connected to the vent opening, the cavity defining a wall portion opposite an inlet of the vent opening to the inside of the package.
